(19) United States
(12) Patent Application Publication
(10) Pub. No.: US 2026/0369109 A1
(43) Pub. Date: Nov. 19, 2026

(54) METHOD FOR TRAINING THE POWER ELECTRONICS OF AN EXHAUST GAS TURBOCHARGER

(71) Applicant: Dr. Ing. h.c. F. Porsche Aktiengesellschaft, Stuttgart (DE)

(72) Inventor: Jens EHRHARDT, Eberdingen (DE)

(21) Appl. No.: 19/454,465

(22) Filed: Jan. 21, 2026

(30) Foreign Application Priority Data
Jan. 22, 2025 (DE) 10 2025 102 224.0

(51) Int. Cl. G07C 5/08; F02B 39/10; G07C 5/00

(52) U.S. Cl. CPC G07C 5/0808; F02B 39/10; G07C 5/008

(57) ABSTRACT

A method trains a power electronics system of a turbocharger of a motor vehicle, where the turbocharger includes an electric machine. The method includes rotating a drive motor of the motor vehicle; subsequently switching off the drive motor; and training the power electronics system after the drive motor is switched off.

### CROSS REFERENCE TO RELATED APPLICATIONS

This application claims benefit to German Patent Application No. DE 10 2025 102 224.0, filed on Jan. 22, 2025.

### FIELD

The present disclosure relates to a method for training a power electronics system of a turbocharger of a vehicle, wherein the turbocharger comprises an electric machine.

### BACKGROUND

DE 102008022911 A1 and DE 102019125658 A1 disclose a lubrication system for an exhaust gas turbocharger.

From DE 102018132191 A1 and US 20120191322 A1, an electrically driven exhaust gas turbocharger is known.

U.S. Pat. No. 6,871,499 B1 and DE 10140944A1 describe a lubrication system for an internal combustion engine.

### SUMMARY

In an embodiment, the present disclosure provides a method for training a power electronics system of a turbocharger of a motor vehicle, wherein the turbocharger includes an electric machine. The method includes rotating a drive motor of the motor vehicle; subsequently switching off the drive motor; and training the power electronics system after the drive motor is switched off.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a turbocharger in a perspective view according to an embodiment of the present disclosure;

FIG. 2 illustrates the turbocharger according to FIG. 1 in a semi-exploded view according to an embodiment of the present disclosure; and

FIG. 3 illustrates a flow chart of a method for training a power electronics system of a turbocharger according to an embodiment of the present disclosure.

### DETAILED DESCRIPTION

Electrically driven and/or electrically assisted turbochargers typically include a power electronics system for driving an electric machine of the turbocharger.

For example, the power electronics system may comprise an inverter for converting a DC current from a battery of the vehicle to an AC current suitable for the electric machine.

For sustainability reasons, the power electronics system should be replaced with as little effort as possible, for example in the event of a defect.

In an embodiment, the present disclosure provides a method by which a component of an electrically driven and/or electrically supported turbocharger can be replaced inexpensively.

A method for training a power electronics system of a turbocharger of a vehicle provides for inexpensive replacement, wherein the turbocharger comprises an electric machine, wherein a drive motor of the vehicle is rotated, wherein the drive motor is subsequently switched off, and wherein the power electronics system is trained after the drive motor is switched off.

One idea underlying aspects of the present disclosure is that, after changing a component of the turbocharger, the turbocharger, e.g., the power electronics system of the turbocharger, generally needs to be trained. In a particular embodiment of the present disclosure, the power electronics system, for example due to tolerances of the electric machine, must be trained on the respective electric machine, and in particular must be calibrated. In the context of initial manufacturing, the turbocharger can be separately inserted into a device specially configured for this purpose. For example, the device may then also provide a supply of lubricating oil during training. However, such a device generally has a high acquisition cost. In general, it is not ensured that such a device is available when the component is replaced. Thus, a significant part of the cost and effort of replacing the component often relates to properly performing the training.

An embodiment of the present disclosure uses already existing elements of the turbocharger instead of the special device that is exclusively used during training, thereby saving acquisition costs and also reducing the cost and effort, because the turbocharger does not need to be installed separately in a special device and removed again therefrom.

In particular embodiments, the drive motor is rotated, as a result of which an oil pressure for a lubricating oil that is lubricating the turbocharger, in particular embodiments its mechanical moving components, can be built up, for example.

In another embodiment, the drive motor is subsequently switched off. As a result, for example, the exhaust flow may be interrupted in an internal combustion engine. The turbocharger can thus be brought into a state necessary for training without the special device being required. In particular embodiments, these two measures can achieve a sufficient oil pressure being applied and thus the moving components of the turbocharger being sufficiently lubricated during training. At the same time, it can achieve the training not being influenced by interfering factors, for example, the exhaust gas flow, and thus the power electronics system being incorrectly or at least not optimally trained.

In particular embodiments, to build up oil pressure, the oil pump typically installed in a vehicle can be used as usual. A connection of an additional oil pump or the like is not required. The oil pump installed in the vehicle can be used because it can typically be driven exclusively by the drive motor, especially in the case of internal combustion engines as drive motors. It is thus driven by the drive motor according to the an embodiment of the present disclosure.

The drive motor can be shut off when an oil pressure of the drive motor has reached or exceeded an oil pressure setpoint. In particular embodiments, the drive motor will continue to operate until a sufficient oil pressure, corresponding to the oil pressure setpoint, is built up. Then, the drive motor can be switched off to cut the exhaust flow, for example, in the case of an internal combustion engine as the drive motor.

The drive motor may be brought to 1000 rpm or more. In particular embodiments, the drive motor may be brought to rotational speeds corresponding to a customary operation of the vehicle. This allows a realistic situation to be created for training.

The drive motor may be thermomechanically rotated. To this end, the drive motor may comprise an internal combustion engine. The vehicle can thus be a vehicle with an internal combustion engine, for example in the form of a hybrid engine or a pure internal combustion engine.

Alternatively, it is also conceivable that the drive motor may be electrically rotated. To this end, in particular embodiments if the vehicle is a hybrid vehicle, an electric machine of the drive motor can be started.

The training may be performed when the oil pressure reaches at least a minimum oil pressure. The minimum oil pressure may be lower than the oil pressure setpoint. For example, the minimum oil pressure may correspond to an oil pressure that is at least required for the moving parts of the turbocharger to be just sufficiently lubricated.

In an embodiment of the present disclosure, for example, once the oil pressure setpoint is reached, the training starts. During training, the oil pressure may drop. If the oil pressure falls below the minimum oil pressure, the training is discontinued, at the latest.

It is particularly advantageous if the method according to an embodiment of the present disclosure is carried out on the turbocharger as part of a component replacement. In this case, the method allows effort and cost to be minimized to a certain extent compared to a full turbocharger removal, installation in a dedicated device, removal again from the device and re-installation in the vehicle.

For a particularly reliable implementation of the method according to an embodiment of the present disclosure, the steps of the method may be controlled by a shop tester. The shop tester may be part of a shop test system. It may comprise a computer that can be connected to a vehicle to be processed, such that the computer can control the vehicle. For example, the computer can be configured to be able to control the vehicle, in particular embodiments the drive motor and the turbocharger, via a so-called OBD II interface and/or via another interface, for example a radio interface.

The method according to an embodiment of the present disclosure may be implemented on the shop tester using a program code executable on the computer through which the respective components of the vehicle, for example the drive motor or turbocharger, are controlled.

Further features and advantages of embodiments of the present disclosure can be found in the following detailed description of an exemplary embodiment of the invention with reference to the figures of the drawing, which show details essential to the invention, and the claims.

The individual features may each be realized individually, or in multiple combinations in any way in variants of the invention. The schematic drawing shows exemplary embodiments of the invention, which are explained in more detail in the following description.

To facilitate understanding of embodiments of the present disclosure, corresponding elements are assigned the same reference numerals in the following figure description.

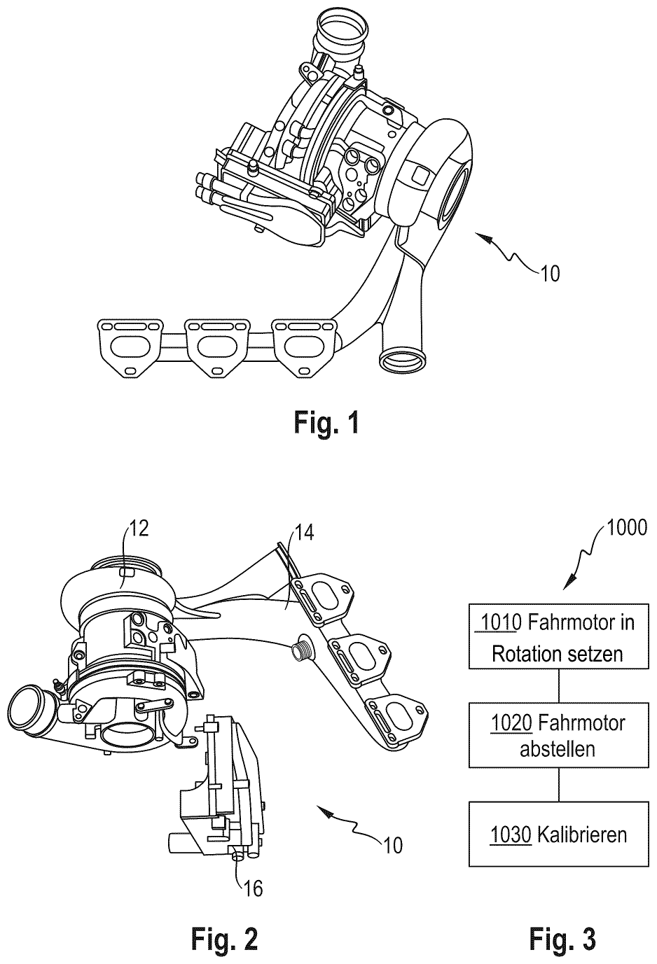

FIG. 1 shows a turbocharger 10 in a perspective view.

FIG. 2 shows a partially exploded view of the turbocharger 10. In particular, a charger 12, an exhaust manifold 14, and power electronics system 16 are depicted in a separate illustration.

The power electronics system 16 includes, among other things, an inverter. It is configured to drive an electric machine in the charger 12.

FIG. 3 illustrates a simplified flow chart of a method 1000 for training the power electronics system 16 of the turbocharger 10. The reference numerals introduced above are used to explain the method 1000.

In a first step 1010 of the method 1000, a drive motor of the vehicle, in which the turbocharger 10 is installed, is rotated. This drives an oil pump of the vehicle such that an oil pressure of a lubricating oil for lubrication of the turbocharger 10 increases.

In a step 1020, once the oil pressure reaches or exceeds an oil pressure setpoint, the drive motor is shut off. The oil pressure setpoint is determined such that the turbocharger 10 is sufficiently lubricated during subsequent training.

The oil pressure setpoint may correspond to an operational oil pressure during ordinary traveling of the vehicle.

After the drive motor is stopped, in a step 1030, the power electronics system 16 is trained with respect to the electric machine being driven.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

10 Turbocharger
12 Charger
14 Exhaust manifold
16 Power electronics system
1000 Method
1010 Step
1020 Step
1030 Step

1. A method for training a power electronics system of a turbocharger of a motor vehicle, wherein the turbocharger comprises an electric machine, the method comprising:
rotating a drive motor of the motor vehicle;
subsequently switching off the drive motor; and
training the power electronics system after the drive motor is switched off.

2. The method according to claim 1, wherein the switching off of the drive motor comprises switching off the drive motor upon an oil pressure of the drive motor having reached or exceeded an oil pressure setpoint.

3. The method according to claim 1, wherein rotating the drive motor comprises bring the drive motor to at least 1000 rpm.

4. The method according to claim 1, wherein rotating the drive motor comprises thermomechanically rotating the drive motor.

5. The method according to claim 1, wherein the rotating the drive motor comprises electrically rotating the drive motor.

6. The method according to claim 1, wherein training the power electronics system further comprises performing the training based on the oil pressure having reached at least a minimum oil pressure.

7. The method according to claim 1, wherein the method is carried out as part of a component replacement on the turbocharger.

8. The method according to claim 1, wherein a shop tester controls the method.
